(19) United States
(12) Patent Application Publication
(10) Pub. No.: US 2009/0203321 A1
(43) Pub. Date: Aug. 13, 2009

(54) Method of estimating electromagnetic wave intensity for mobile communication device and mobile communication device thereof

(75) Inventor: Wen-Jui Hsu, Taipei (TW)

Correspondence Address: REED SMITH LLP, 3110 Fairview Park Drive, Suite 1400, Falls Church, VA, 22042, US

(73) Assignee: Compal Communications, Inc.

(21) Appl. No.: 12/318,622

(22) Filed: Jan. 2, 2009

(30) Foreign Application Priority Data
Jan. 4, 2008 (TW) 097100288

(51) Int. Cl. H04B 17/00

(52) U.S. Cl. 455/67.11

(57) ABSTRACT

The present invention provides a method and an apparatus of estimating the intensity of the electromagnetic wave of a mobile communication device. According to the method of the present invention, step (a) is firstly performed to retrieve a transmission power of the mobile communication device. Secondly, step (b) is performed in the method of the invention to estimate the intensity of electromagnetic wave based on the transmission power. Finally, step (c) is performed in the method of the invention to display the intensity of electromagnetic wave.

### BACKGROUND OF THE INVENTION

1. Field of the Invention

The present invention relates generally to a mobile communication device, and more particularly, to a method and an apparatus of estimating the intensity of an electromagnetic wave of a mobile communication device.

2. Description of the Prior Art

With the development of mobile communication technology, mobile phone has gradually become an indispensable part of our everyday life. Although whether the electromagnetic wave generated by a mobile phone is harmful to human body has not been proved yet, the argument has often been discussed recently. Many users wish to get the information about the intensity of the electromagnetic wave generated by a mobile phone while using the device, and use it as a reference while using it.

With different operating areas, the trademarks of mobile phones, and tele-communication services such as GSM, PHS, GPRS, UMTS, HSDPA, SMS/MMS, etc., the intensity of the electromagnetic wave generated by the mobile phone differs. In the past, the electromagnetic wave generated by a mobile phone was measured by a professional measuring machine, and the measuring position was limited in some specific places. That led to the fact that every telecommunication company adopted measured data which benefit itself and claimed that electromagnetic wave generated from their telecommunication service was the lowest. Thereby, users still can not obtain true information about the intensity of the electromagnetic wave generated by a mobile phone while using it.

Accordingly, the main purpose of the present invention is to provide a method and an apparatus of estimating the intensity of the electromagnetic wave of a mobile communication device to solve the problems mentioned above.

### SUMMARY OF THE INVENTION

The present invention provides a method and an apparatus of estimating the intensity of electromagnetic wave of a mobile communication device. Different from the professional measuring machine in the prior art, the method of the present invention reaches the effect by using devices which the mobile communication device already had without adding any extra measuring machines and cost.

According to a preferred embodiment of the present invention, the mobile communication device is for retrieving a transmission power of the mobile communication device, translating the transmission power into a corresponding intensity of an electromagnetic wave, and displaying the intensity degree of the electromagnetic wave on the screen to notify users of the corresponding intensity of the electromagnetic wave generated by the mobile communication device on the go. Meanwhile, the mobile communication device of the present invention could record the intensity degree of the electromagnetic wave and enables the users to inquire about the statistically analyzed result of the previous intensity degree of the electromagnetic wave by means of the man machine interface (MMI).

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 is a flow chart illustrating a method of estimating an intensity of an electromagnetic wave according to a preferred embodiment of the present invention.

FIG. 2 is a flow chart illustrating the method of estimating an intensity of an electromagnetic wave in FIG. 1 further comprising other steps.

FIG. 3 is a functional block demonstrating an apparatus of estimating an intensity of an electromagnetic wave according to another preferred embodiment of the present invention.

FIG. 4 is a functional block demonstrating the apparatus of estimating an intensity of an electromagnetic wave in FIG. 3 further comprising a memory and a statistic module.

### DETAILED DESCRIPTION OF THE INVENTION

The present invention provides a method and an apparatus of estimating the intensity of the electromagnetic wave of a mobile communication device.

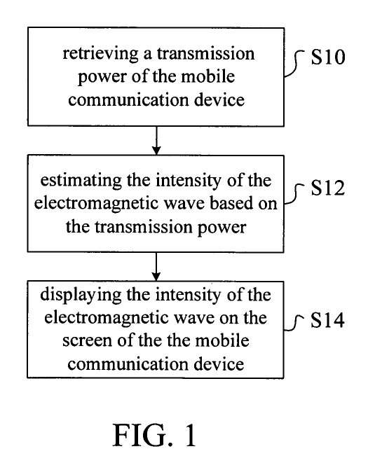

A preferred embodiment of the present invention is a method of estimating the intensity of the electromagnetic wave of a mobile communication device. Please refer to FIG. 1. FIG. 1 is a flow chart illustrating the method of estimating the intensity of the electromagnetic wave according to the preferred embodiment.

Firstly, step S10 is performed in the method of the invention to retrieve a transmission power of the mobile communication device. Secondly, step S12 is performed in the method of the invention to estimate the intensity of the electromagnetic wave based on the transmission power. Finally, step S14 is performed in the method of the invention to display the intensity of the electromagnetic wave.

In a practical application, when estimating the intensity of an electromagnetic wave based on the transmission power in the method, the transmission power could be compared with a look-up table which stores a plurality of sets of power range and a plurality of default intensities of electromagnetic waves, and each set of power range is corresponding to one of the plurality of default intensities of electromagnetic waves respectively, so the intensity of the electromagnetic wave can be obtained from the plurality of default intensities of electromagnetic waves.

Moreover, in another practical application, a mathematical transformation equation could be used to estimate the intensity of electromagnetic wave based on the relation between the transmission power and the intensity of electromagnetic wave.

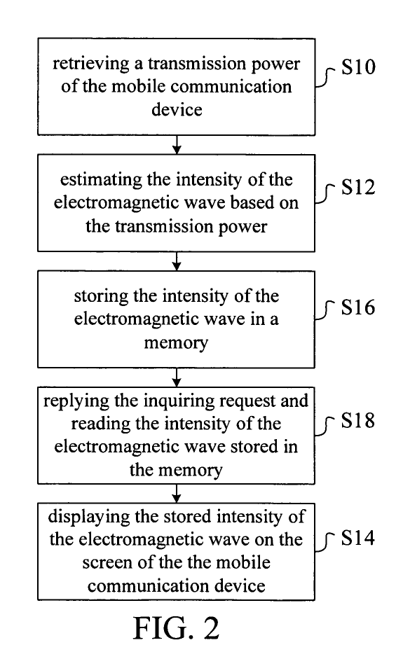

Another preferred embodiment of the present invention is also a method of estimating the intensity of the electromagnetic wave of a mobile communication device. Please refer to FIG. 2. FIG. 2 is a flow chart illustrating the method of estimating an intensity of an electromagnetic wave according to the preferred embodiment.

As illustrated in FIG. 2, the method of estimating the intensity of the electromagnetic wave in FIG. 1 further comprises step S16 and step S18. In practical applications, the intensity of the electromagnetic wave is not necessarily shown on the screen of the mobile communication device immediately.

For example, step S16 could be performed in the method to store the intensity of the electromagnetic wave in a memory. Once users send an inquiring request by the man machine interface (MMI) to inquire the intensity of the electromagnetic wave of the mobile communication device, step S18 and step S14 could be performed to read the intensity of the electromagnetic wave stored in the memory and the screen of the mobile communication device displays the stored intensity of the electromagnetic wave.

Furthermore, the method of the present invention could further statistically analyze the intensity of the electromagnetic wave stored in the memory. Users could inquire the statistically analyzed result of the intensity degree of the electromagnetic wave and use it as a reference while operating the device.

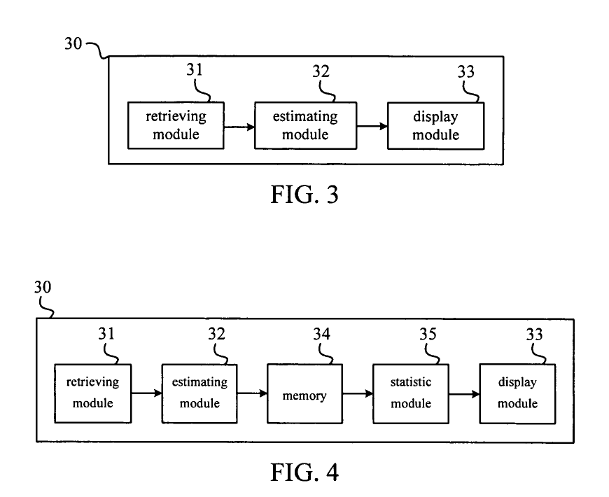

Yet another preferred embodiment of the present invention is an apparatus of estimating the intensity of the electromagnetic wave of a mobile communication device. Please refer to FIG. 3. FIG. 3 is a functional block demonstrating the apparatus of estimating the intensity of the electromagnetic wave according the preferred embodiment of the present invention.

The apparatus of estimating an intensity of an electromagnetic wave 30 comprises a retrieving module 31, an estimating module 32 and a display module 33. The retrieving module 31 is for the retrieving of a transmission power of the mobile communication device. The estimating module 32 is for the estimating of the intensity of the electromagnetic wave according to the transmission power. The display module 33 is for the displaying of the intensity of the electromagnetic wave.

In practical applications, the estimating module 32 compares the transmission power with a look-up table to obtain the intensity of an electromagnetic wave. The look-up table stores a plurality of sets of power ranges and a plurality of default intensities of electromagnetic waves, and each set of power range is corresponding to one of the plurality of default intensities of electromagnetic waves. After the estimating module 32 compares the transmission power with the look-up table, the intensity of the electromagnetic wave could be obtained from the result chosen among the plurality of default intensities of electromagnetic waves.

Additionally, in practical applications, the estimating module 32 could estimate the intensity of electromagnetic wave based on the relation between the transmission power and the intensity of electromagnetic wave by means of a mathematical transformation equation.

As illustrated in FIG. 4, according to another embodiment, the apparatus of estimating the intensity of the electromagnetic wave 30 could further comprise a memory 34 and a statistic module 35.

The memory 34 is for the storing of the intensity of the electromagnetic wave. The statistic module 35 is for statistically compiling the intensity of the electromagnetic wave. The retrieving module 31 could store the retrieved intensity of the electromagnetic wave in the memory 34. The statistic module 35 is for reading the intensity of the electromagnetic wave stored in the memory 34 and statistically analyzing the stored intensity of the electromagnetic wave.

Once users send an inquiring request by the man machine interface (MMI) to inquire the intensity of the electromagnetic wave, the apparatus for estimating an intensity of an electromagnetic wave 30 reads the data from the memory 34 and displays the statistically analyzed result on the screen. Thereby, users could use it as a reference while operating the device.

Please continuously refer to FIG. 4, for example, the transmission power of the mobile communication device could be divided into five sets of power range, these sets of power range are stored in a look-up table in the memory 34. The five sets of power range are corresponding to five intensity degrees of electromagnetic waves respectively.

The memory 34 also stores the definition of each intensity degree of the electromagnetic wave. Users could send an inquiring request by the man machine interface (MMI) to inquire the definition of the intensity of an electromagnetic wave. Meanwhile, the apparatus of estimating an intensity of an electromagnetic wave 30 reads the data from the memory 34 and displays the definition of intensity of the electromagnetic wave on the screen. Thus, users could use it as a reference while operating the device.

For example, the statistic module 35 of the mobile communication device could read the intensity of the electromagnetic wave stored in the memory 34, which shows it is over the third intensity degree during a specific period (such as in one day, in a week, in a month or in a year), and statistically compiles the number of times. Furthermore, the statistic module 35 could compile the total time of operation on the mobile communication device when the intensity of the electromagnetic wave is over the third intensity degree. Thus, users could use it as a reference while operating the device.

Please continuously refer to FIG. 4. In an extra embodiment, the mobile communication device could also be integrated with a warning unit. For example, when the intensity of the electromagnetic wave reaches the fifth intensity degree, then the apparatus for estimating an intensity of an electromagnetic wave 30 drives the warning unit to display a warning message says “the intensity of the electromagnetic wave is too high” on the display module 33, or drives the mobile communication device to vibrate to warn the users.

Compared to prior art, the method and the apparatus of estimating an intensity of an electromagnetic wave of the invention reaches the effect without adding any extra measuring machines and cost.

Although the present invention has been illustrated and described with reference to the preferred embodiment thereof, it should be understood that it is in no way limited to the details of such embodiment but is capable of numerous modifications within the scope of the appended claims.

What is claimed is:

1. A method of estimating an intensity of an electromagnetic wave of a mobile communication device, the method comprising the following steps:
(a) retrieving a transmission power of the mobile communication device; and
(b) estimating the intensity of the electromagnetic wave based on the transmission power.

2. The method of claim 1, wherein step (b) is to compare the transmission power with a look-up table which stores a plurality of sets of power range and a plurality of default intensities of electromagnetic waves, and each set of power range is corresponding to one of the plurality of default intensities of electromagnetic waves respectively, to obtain the intensity of the electromagnetic wave from the plurality of default intensities of electromagnetic waves.

3. The method of claim 1 further comprising the following step:
(c) displaying the intensity of the electromagnetic wave.

4. The method of claim 3 further comprising the following step:
(d) storing the intensity of the electromagnetic wave in a memory.

5. The method of claim 4, wherein step (c) is to respond to an inquiring request, to read the stored intensity of the electromagnetic wave from the memory, and to display the intensity of the electromagnetic wave.

6. The method of claim 4 further comprising the following step:
(e) reading the intensity of the electromagnetic wave stored in the memory and statistically compiling the intensity of the electromagnetic wave.

7. A mobile communication device comprising:
a retrieving module for retrieving a transmission power of the mobile communication device; and
an estimating module for estimating an intensity of an electromagnetic wave according to the transmission power.

8. The mobile communication device of claim 7, wherein the estimating module compares the transmission power with a look-up table which stores a plurality sets of power range and a plurality of default intensities of electromagnetic waves, and each set of the power range is corresponding to one of the plurality of default intensities of electromagnetic waves, to obtain the intensity of the electromagnetic wave from the plurality of default intensities of electromagnetic waves.

9. The mobile communication device of claim 7 further comprising:
a display module for displaying the intensity of the electromagnetic wave.

10. The mobile communication device of claim 9 further comprising:
a memory for storing the intensity of the electromagnetic wave.

11. The mobile communication device of claim 10, wherein the display module is responsible for an inquiring request, and is for the displaying of the intensity of the electromagnetic wave after the memory reading the stored intensity of the electromagnetic wave.

12. The mobile communication device of claim 10 further comprising:
a statistic module for reading the intensity of the electromagnetic wave stored in the memory and statistically analyzing the intensity of the electromagnetic wave.
